(19) United States
(12) Patent Application Publication
(10) Pub. No.: US 2006/0062303 A1
(43) Pub. Date: Mar. 23, 2006

(54) Hybrid global motion estimator for video encoding

(75) Inventor: Xun Xu, San Jose, CA (US)

Correspondence Address: Jonathan O. Owens;HAVERSTOCK & OWENS LLP, 162 North Wolfe Road, Sunnyvale, CA, 94086, US

(73) Assignees: Sony Corporation; Sony Electronics Inc.

(21) Appl. No.: 10/943,625

(22) Filed: Sep. 17, 2004

(51) Int. Cl. H04N 11/02; H04N 11/04; H04N 7/12; H04B 1/66

(52) U.S. Cl. 375/240.16; 375/240.21; 375/240.24

(57) ABSTRACT

A method and system for detecting and estimating global motion among video frames includes down sampling a first and a second video frame to a low resolution version (I1, I2) and performing a block matching on the low resolution images by treating both images (I1, I2) as two single blocks. This method and system therefore utilizes low-frequency picture information, resulting in a motion vector (U,V), and the second low resolution image I2 being segmented into two regions, a region of high matching difference and a region of low matching difference. The method and system then refines the motion vector (U,V) by calculating the horizontal, vertical, zooming and rotation motion components (Tₓ, T_{y}, T_{z}, Tᵣ), based on the pixels in the region of low matching difference, by gradient-based method.

### RELATED APPLICATION(S)

This Patent Application claims priority under 35 U.S.C. § 119(e) of the co-pending U.S. Provisional Patent Application, Ser. No. 60/469,302, filed May 9, 2004, and entitled “HYBRID GLOBAL MOTION ESTIMATOR FOR VIDEO ENCODING.” The Provisional Patent Application, Ser. No. 60/469,302, filed May 9, 2004, and entitled “HYBRID GLOBAL MOTION ESTIMATOR FOR VIDEO ENCODING” is also hereby incorporated by reference in its entirety.

### FIELD OF THE INVENTION

The present invention relates to the field of video encoding. More particularly, the present invention relates to detecting and estimating global motion among video frames.

### BACKGROUND

Global motion refers to the apparent two-dimensional image motion induced by camera operation. The most commonly observed global motion includes the shifting, rotation, expansion and shrinking of the image content, that is caused by pan and tilt, rotating and zooming of the video camera. The global motion is mathematically modeled by a few parameters. Global motion estimation is the procedure of determining these parameters.

Current technologies of motion estimation (global or local) can be roughly divided into three categories. One prior art solution is called block matching. The computational complexity of block matching is moderate. This block matching solution is capable of detecting large motion between frames, though the estimation accuracy is limited by the image resolution. Block matching is good for detecting the motion of shifting. The computational complexity increases drastically if it is used to estimate the zoom and rotation components.

Another prior art solution includes one based on computations involving the image gradients. The computational complexity of this gradient-based method is low. It is capable of detecting all four of the motion components (horizontal and vertical shifting, zooming, rotation), and achieves a higher accuracy that is not limited by the image resolution. The down side of this image gradient solution is that it is not able to estimate motion larger than one pixel. Another prior art solution includes one based on the matching of prominent features between frames.

Global motion information is useful in applications such as video compression. A critical step in video compression is encoding the motion in the image efficiently. The global motion information enables the encoder to describe large area of motion with simply a few uniform parameters. In addition to increasing video coding efficiency, the results are also useful for applications such as video segmentation and video content description.

No technique has as yet been devised that incorporates high vertical and horizontal motion shifting detection with the capability to detect all four motion components and a very low computational complexity.

### SUMMARY

A method and system for detecting and estimating global motion among video frames includes down sampling a first and a second video frame to a low resolution version (I1, I2) and performing a block matching on the low resolution images by treating both low resolution images (I1,I2) as two single blocks and discarding picture details. This method and system therefore utilizes low frequency picture information, resulting in a motion vector (U,V), and the second low resolution image I2 being segmented into two regions, a region of high matching difference and a region of low matching difference. The method and system then refines the motion vector (U,V) by calculating the horizontal, vertical, zooming and rotation motion components (Tₓ, T_{y}, T_{z}, Tᵣ), based on the pixels in the region of low matching difference, by gradient-based method.

In one aspect of the present invention, a method of estimating video global motion comprises down-sampling a first video frame and a second video frame, wherein the down-sampling produces a first low resolution image and a second low resolution image, the first low resolution image corresponding to the first video frame and the second low resolution image corresponding to the second video frame, block matching the first low resolution image and the second low resolution image, wherein the block matching produces a motion vector and performing a gradient-based estimation on the first low resolution image and the second low resolution image, wherein the gradient-based estimation includes the motion vector, and further wherein an estimated global motion is calculated.

The method further comprises receiving the first video frame and the second video frame from a camera or a storage device, applying the estimated global motion to a selected application and transmitting the first video frame and the second video frame to a display when the estimated global motion is calculated. The method further comprises transmitting the first video frame and the second video frame to a storage device or an application when the estimated global motion is calculated. The block matching includes utilizing a plurality of pixels, further wherein the plurality of pixels have position coordinates in x and y directions and calculates a lowest sum of absolute differences.

The method further comprises segmenting the second low resolution image into two regions according to the motion vector. The gradient-based estimation includes refining the motion vector and calculating a set of motion components, further wherein the motion components include a horizontal component, a vertical component, a zooming component and a rotational component. The motion components are calculated with a least squares method.

In another aspect of the present invention, a system for estimating video global motion comprises means for down-sampling a first video frame and a second video frame, wherein the means for down-sampling produces a first low resolution image and a second low resolution image, the first low resolution image corresponding to the first video frame and the second low resolution image corresponding to the second video frame, means for block matching the first low resolution image and the second low resolution image, wherein the block matching produces a motion vector and means for performing a gradient-based estimation on the first low resolution image and the second low resolution image, wherein the means for performing the gradient-based estimation includes the motion vector, and further wherein an estimated global motion is calculated.

The system further comprises means for receiving the first video frame and the second video frame from a camera or a storage device, means for applying the estimated global motion to a selected application and means for transmitting the first video frame and the second video frame to a display when the estimated global motion is calculated. The system further comprises means for transmitting the first video frame and the second video frame to a storage device or an application when the estimated global motion is calculated. The means for block matching includes means for utilizing a plurality of pixels, further wherein the plurality of pixels have position coordinates in x and y directions. The means for block matching calculates a lowest sum of absolute differences.

The system further comprises means for segmenting the second low resolution image into two regions according to the motion vector. The means for gradient-based estimation includes means for refining the motion vector and means for calculating a set of motion components, further wherein the motion components include a horizontal component, a vertical component, a zooming component and a rotational component. The motion components are calculated with a least squares method.

In another aspect of the present invention, a system for estimating video global motion comprises a receiver configured to receive a first video frame and a second video frame and a processor coupled to the receiver, wherein the processor is configured to down sample the first video frame and the second video frame, wherein the down-sampling produces a first low resolution image and a second low resolution image, the first low resolution image corresponding to the first video frame and the second low resolution image corresponding to the second video frame, block match the first low resolution image and the second low resolution image, wherein the block matching produces a motion vector and perform a gradient-based estimation on the first low resolution image and the second low resolution image, wherein the gradient-based estimation includes the motion vector, and further wherein an estimated global motion is calculated. The receiver receives the first video frame and the second video frame from a camera or a storage device. The processor is configured to apply the estimated global motion to a selected application.

The system further comprises a transmitter configured to transmit the first video frame and the second video frame to a display, a storage device or an application when the estimated global motion is calculated. The transmitter is configured to transmit the first video frame and the second video frame to a storage device when the estimated global motion is calculated. When the processor performs block matching, a plurality of pixels is utilized, further wherein the plurality of pixels have position coordinates in x and y directions. Block matching calculates a lowest sum of absolute differences. The processor is configured to segment the second low resolution image into two regions according to the motion vector. When the processor performs gradient-based estimation, the motion vector is refined and a set of motion components is calculated, further wherein the motion components include a horizontal component, a vertical component, a zooming component and a rotational component. The motion components are calculated with a least squares method.

In another aspect of the present invention, a method of estimating video global motion comprises receiving a first video frame and a second video frame, down-sampling the first video frame and the second video frame, wherein the down-sampling produces a first low resolution image and a second low resolution image, the first low resolution image corresponding to the first video frame and the second low resolution image corresponding to the second video frame, block matching the first low resolution image and the second low resolution image, wherein the block matching produces a motion vector, performing a gradient-based estimation on the first low resolution image and the second low resolution image, wherein the gradient-based estimation includes the motion vector, and further wherein an estimated global motion is calculated, applying the estimated global motion to a selected application and transmitting the first video frame and the second video frame. The first video frame and the second video frame are received from a camera or a storage device.

The first video frame and the second video frame are transmitted to a display, a storage device or an application when the estimated global motion is calculated. The block matching includes utilizing a plurality of pixels, further wherein the plurality of pixels have position coordinates in x and y directions. The block matching calculates a lowest sum of absolute differences.

The method further comprises segmenting the second low resolution image into two regions according to the motion vector. The gradient-based estimation includes refining the motion vector and calculating a set of motion components, further wherein the motion components include a horizontal component, a vertical component, a zooming component and a rotational component. The motion components are calculated with a least squares method.

In another aspect of the present invention, a system for estimating video global motion comprises a processing circuit for down-sampling a first video frame and a second video frame, wherein the processing circuit for down-sampling produces a first low resolution image and a second low resolution image, the first low resolution image corresponding to the first video frame and the second low resolution image corresponding to the second video frame, a matching circuit for block matching the first low resolution image and the second low resolution image, wherein the block matching produces a motion vector and an estimating circuit for performing a gradient-based estimation on the first low resolution image and the second low resolution image, wherein the estimating circuit for performing the gradient-based estimation includes the motion vector, and further wherein an estimated global motion is calculated.

The system further comprises a receiver for receiving the first video frame and the second video frame from a camera or a storage device, an application circuit for applying the estimated global motion to a selected application and a transmitter for transmitting the first video frame and the second video frame to a display, a storage device or an application, when the estimated global motion is calculated. The matching circuit for block matching utilizes a plurality of pixels, further wherein the plurality of pixels have position coordinates in x and y directions. The matching circuit for block matching calculates a lowest sum of absolute differences.

The system further comprises a segmenting circuit for segmenting the second low resolution image into two regions according to the motion vector. The estimating circuit for gradient-based estimation refines the motion vector and calculates a set of motion components, further wherein the motion components include a horizontal component, a vertical component, a zooming component and a rotational component. The motion components are calculated with a least squares method.

### BRIEF DESCRIPTION OF THE DRAWINGS

FIG. 1 illustrates a graphical depiction of a method of detecting and estimating global motion among video frames.

FIG. 2 illustrates a block diagram of a system for detecting and estimating global motion among video frames.

FIG. 3 illustrates a flow chart of detecting and estimating global motion among video frames.

### DETAILED DESCRIPTION OF THE EMBODIMENTS

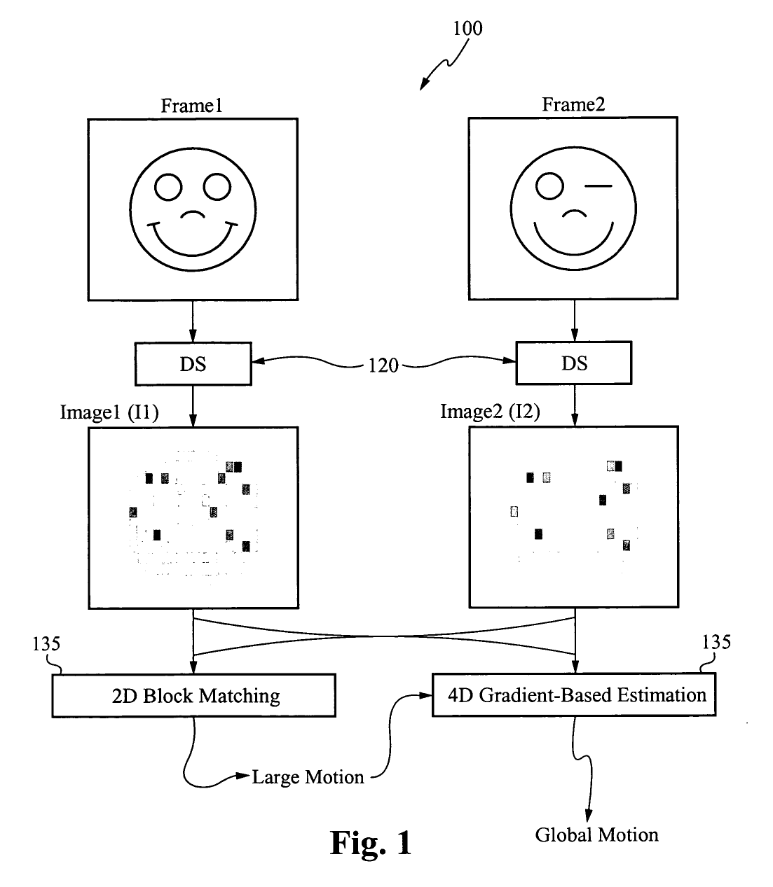

A method and system for global motion detection and estimation incorporating block matching with a gradient-based method is herein disclosed. For a video sequence, large motion tends to be shifting that is caused by the pan and tilt of the camera. The components of zooming and rotation are relatively small. Accordingly, 2D block matching may be used to estimate the large shifting motion. After the large motion is compensated for in the frames, a 4D gradient-based estimation is performed to refine the results of the 2D block matching. An embodiment of the method 100 is depicted in FIG. 1.

Referring to FIG. 1, the method 100 includes a pair of video frames, Frame 1 and Frame 2. Frame 1 and Frame 2 are successive in a video stream. In the method 100 of detecting and estimating the global motion between Frame 1 and Frame 2, a down sampling step 120 is performed on both Frame 1 and Frame 2 to produce a pair of low resolution images, Image 1 (I1) and Image 2 (I2). By down-sampling, in this manner, only low frequency information from the input frames Image 1 (I1) and Image 2 (I2) is utilized in the computations that follow. One skilled in the art will be versed in the known methods of down sampling, and further will know that low resolution includes an image size of 44×36 for Common Intermediate Format (CIF) or Quarter Common Intermediate Format (QCIF), or an image size substantially close to that.

Still referring to FIG. 1, a 2D block matching step 135 is utilized in order to detect large camera motion from I1 to I2. In this step, both the Image 1 (I1) and the Image 2 (I2) are treated as two single blocks. Pixels in the Image 1 (I1) and the Image 2 (I2) have position coordinates in x and y directions, and are represented accurately by the notation I₁(x,y) or I₂(x,y). The 2D block matching step 135 includes calculating the sum of absolute differences (SAD) of each possible matching position and determining the lowest sum of absolute differences (SAD).

The 2D block matching step 135 outputs a motion vector (U,V), which is the matching position that has the lowest sum of absolute differences (SAD). Also, as a result of the 2D block matching step 135, I2 is segmented into two regions, according to matching differences with the motion vector (U,V). The motion vector (U,V) is then applied in the 4D gradient-based estimation step 140 to calculate the global motion.

The Image 2 (I2) is segmented into two regions, including a region of high matching difference and a region of low matching difference. Only the pixels in the region of low matching difference are utilized in the following gradient-based estimation. In the 4D gradient-based estimation step 140, the motion vector (U,V) is refined to calculate the global motion between I1 and I2. In this step, every pixel I₂(x,y) in the low matching difference region gives the following constraint:
Eₜ+EₓTₓ+E_{y}T_{y}+(xEₓ+yE_{y})T_{z}+(yEₓ−xE_{y})T_{R}=0

In this constraint, Eₜ(x,y)=I₂(x,y)−I₁(x+U, y+V), Eₓ, E_{y} are the horizontal gradients of I₂(x,y), and Tₓ, T_{y}, T_{z} and T_{R} are the horizontal, vertical, zooming and rotational motion components. In this 4D gradient-based estimation step 140, there are many pixels and just one set of unknowns (Tₓ, T_{y}, T_{z}, T_{R}). Therefore, the solution is over-constrained and the unknowns (Tₓ, T_{y}, T_{z}, T_{R}) are computed through the least squares method. Considering the large motion vector (U,V), Tₓ and T_{y} are modified:
Tₓ=Tₓ−U,T_{y}=T_{y}−V

This motion result has a much higher accuracy than if the 2D block matching step 135 were performed alone. The derivation of the above constraint that is used in the 4D gradient-based estimation step 140 is illustrated by the following formula progression, where I1 is assumed to be equal to I2 plus the motion vector (u,v):
I₁(x,y)=I₂(x+u,y+v)
and the motion vector (u,v) is separated from I₂(x,y) by calculating the derivatives of I₂(x,y) in the x-direction and the y-direction as follows:

$${I}_{1} ( x , y ) = {I}_{2} ( x , y ) + u [ \frac{ⅆ {I}_{2} ( x , y )}{ⅆ x} ] + v [ \frac{ⅆ {I}_{2} ( x , y )}{ⅆ y} ] ; where \\ [ \begin{matrix}u \\ v\end{matrix} ] = [ \begin{matrix}1 & 0 & x & y \\ 0 & 1 & y & x\end{matrix} ] [ \begin{matrix}Tx \\ Ty \\ Tz \\ Tr\end{matrix} ] and therefore$$

$${I}_{1} ( x , y ) = {I}_{2} ( x , y ) + [ \begin{matrix}\frac{ⅆ I2}{ⅆ x} & \frac{ⅆ I2}{ⅆ y}\end{matrix} ] [ \begin{matrix}u \\ v\end{matrix} ] \\ = {I}_{2} ( x , y ) + [ \begin{matrix}\frac{ⅆ I2}{ⅆ x} & \frac{ⅆ I2}{ⅆ y}\end{matrix} ] [ \begin{matrix}1 & 0 & x & y \\ 0 & 1 & y & x\end{matrix} ] [ \begin{matrix}Tx \\ Ty \\ Tz \\ Tr\end{matrix} ]$$

Here,

$$\frac{ⅆ I2}{ⅆ x}$$

produces Ex,

$$\frac{ⅆ I2}{ⅆ y}$$

produces Ey, and without considering large motion compensation, I2(x,y)−I1(x,y) produces Et.

Because the 2D block matching step 135 and the 4D gradient-based estimation step 140 are performed on low resolution images, I1 and I2, the computational cost is very small. Furthermore, the 4D gradient-based estimation step 140 may be performed in other ways known to one skilled in the art such as in an iterative fashion to remove outliers in the least squares estimation. Also in the 4D gradient-based estimation step 140, if the user is certain that some motion components do not exist, e.g. there is no zoom or rotational motion, then the related terms may be removed from the equation. The method 100 therefore utilizes the 2D block matching step 135 to detect large camera motion that usually includes shifting components, while the 4D gradient-based estimation step 140 is used to refine the shifting components and determine the zooming and rotation components.

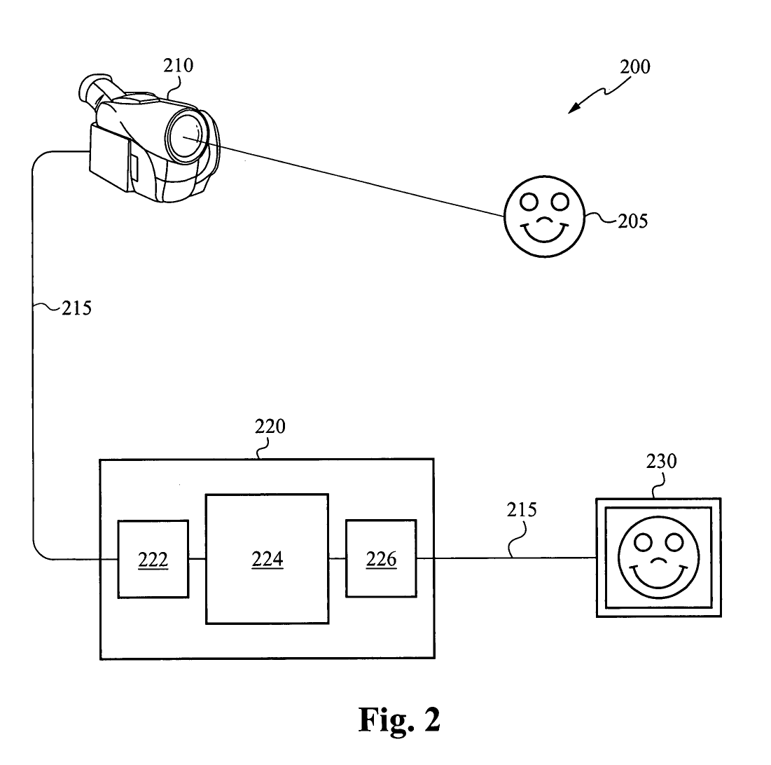

FIG. 2 illustrates a video system 200 of an embodiment of the invention including a camera 210, video transmission lines 215, a display 230 and a computer 220. The computer 220 includes a receiver 222, a processor 224 and a transmitter 226. In an embodiment of the invention, a live image 205 is captured by the camera 210, and the video frames are transmitted to the computer 220 through the video transmission line 215. Alternatively, the image 205 is input to the computer 220 from any other appropriate device, such as a storage device that has saved previously taken video. In the computer 220, the video frames are received in a receiver 222, and transferred to a processor 224. The processor performs the method 100 as described in FIG. 1 and utilizes the global motion estimate produced by the method 100.

Still referring to FIG. 1 and FIG. 2, some examples of applications that utilize the method 100 include video compression, for the low computational cost, as well as its capabilities of detecting large camera motion. In addition to increasing video coding efficiency, the method 100 is also useful for video segmentation, video filtering and video content description. This, of course, is not an exhaustive list of applications for the method 100, but is rather an exemplary list.

Referring back to FIG. 2, the processor 224 utilizes the method 100 (FIG. 1) to a pair of video frames as described above. The processor 224 down samples the video frames to a pair of low resolution images before applying the 2D block matching step and 4D gradient-based estimation step. The processor 224 then applies the estimated global motion results to the desired application as listed above, e.g. compression, segmentation, etc., before the transmitter 226 receives the output of the processor 224. This data is then transmitted across the video transmission line 215 to the display 230. It should be apparent that the data can be transmitted across the video transmission line 215 to any other appropriate device and/or application, such as a storage element, appropriately configured to the selected application.

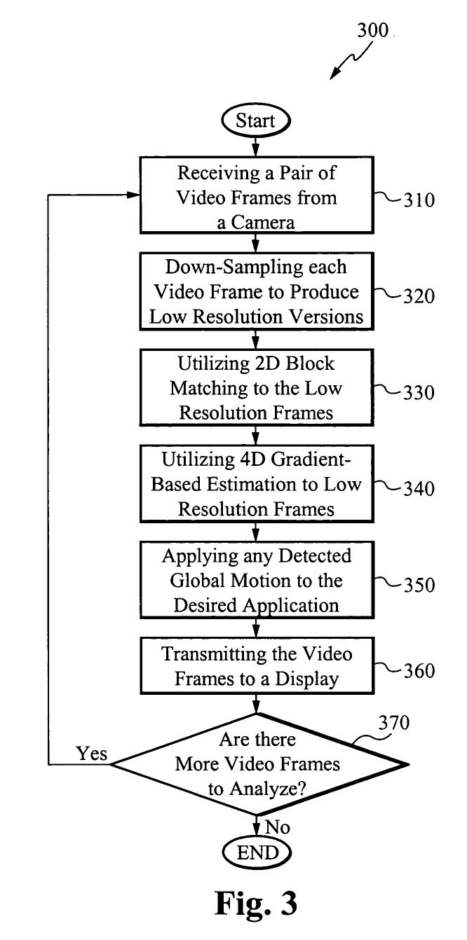

Referring now to FIG. 3, a flow chart of detecting and estimating global motion among video frames is depicted. In step 310 of the method 300, a pair of video frames are received from a camera. In step 320, the video frames are down-sampled to produce a pair of low resolution video frames corresponding to the video frames received in step 310. In step 330, a 2D block matching technique is utilized on the low resolution video frames. The 2D block matching treats the entire low resolution image as two single blocks.

The 2D block matching outputs a motion vector. (U,V), which is the matching position with the lowest sum of absolute differences (SAD). Also, as a result of the 2D block matching, the second low resolution image is segmented into two regions, according to matching differences with the motion vector (U,V). The motion vector (U,V) is then applied in the 4D gradient-based estimation technique in step 340.

Still referring to FIG. 3, in step 340, a 4D gradient-based estimation technique is utilized on the low resolution frames, while factoring in the motion vector (U,V). In 4D gradient-based estimation, the motion vector (U,V) is refined to calculate the global motion between the pair of low resolution frames. In step 340, every pixel in the low matching difference region gives the following constraint:
Eₜ+EₓTₓ+E_{y}T_{y}+(xEₓ+yE_{y})T_{z}+(yEₓ−xE_{y})T_{R}=0;
and in this constraint,
Eₜ(x,y)=I₂(x,y)−Iₗ(x+U,y+V), Eₓ,E_{y}
are the horizontal gradients of the second low resolution frame, and Tₓ, T_{y}, T_{z} and T_{R} are the horizontal, vertical, zooming and rotational motion components. Also in step 340, the set of unknowns (Tₓ, T_{y}, T_{z}, T_{R}) are computed through the least squares method. Considering the large motion vector, (U,V), Tₓ and T_{y} are modified to Tₓ=Tₓ−U, T_{y}=T_{y}−V.

Still referring to FIG. 3, when the 2D block matching and 4D gradient-based estimation techniques are applied to the low resolution images, then any global motion that is detected is applied to and correct in the desired application. Global motion detection is useful in such applications as increasing video coding efficiency, video segmentation, video filtering and video content description. In step 360, the video frames are transmitted to a display for viewing, or to a storage device or some other appropriate device or application, depending on the application being utilized. In step 370, if there are more video frames available, then the method 300 returns to step 310 to receive additional frames from the camera. In step 370, if there are no more frames available, then the method 300 ends.

In operation, the video system 200 includes an input device, such as a camera 210 or a storage device, a computer 220 and a display 230 or any appropriate device such as a storage device. The computer 220 includes a receiver 222, a processor 224 and a transmitter 226, wherein the computer 220 communicates with the camera 210 and the display 230 over transmission lines 215. The transmission lines 215 are any appropriate medium including but not limited to a wired or wireless local or wide area network. In operation, the camera 210 captures a live image 205 and sends the video frames of the live image 205 to the computer 220 through the transmission lines 215. The video frames are received in a receiver 222, and transferred to a processor 224.

In operation, the processor 224 performs down-sampling on two consecutive images to produce two corresponding low resolution images. Creating the low resolution versions of the video frames reduces the overall computational costs of global motion detection and estimation. The processor 224 then performs a 2D block matching operation to the pair of low resolution images. In operation, this 2D block matching operation detects large motion shifts caused by the pan and tilt of the camera. Therefore, the 2D block matching operation is utilized in order to detect and estimate the large vertical and horizontal motion in a simple and inexpensive fashion prior to detecting and estimating the rotational and zoom components of the motion.

In operation, once the processor 224 has estimated the large horizontal and vertical motion components efficiently and effectively, the processor 224 then will perform a 4D gradient-based estimation to the low resolution images in order to refine the motion vector calculated from the 2D block matching process. By utilizing the 4D gradient-based estimation after the 2D block matching process, the 4D gradient-based estimation is able to detect and estimate all four motion components (vertical, horizontal, zoom, and rotation), which is a simple computational process.

In operation, the processor 224 then applies the results to the appropriate application. This operation fits extremely well in applications such as video compression because of the advantages of low computational cost, as well as its capabilities of detecting large camera motion. In addition to increasing video coding efficiency, the results are also useful for video segmentation and video content description. In operation, the transmitter 226 will then transmit the video frames, through the transmission lines 215 to a display 230 for viewing. As appropriate, the system can transfer the video frames to other devices such as a storage device.

The present invention has been described in terms of specific embodiments incorporating details to facilitate the understanding of the principles of construction and operation of the invention. Such reference herein to specific embodiments and details thereof is not intended to limit the scope of the claims appended hereto. It will be apparent to those skilled in the art that modifications can be made in the embodiment chosen for illustration without departing from the spirit and scope of the invention. Specifically, it will be apparent to one of ordinary skill in the art that the device of the present invention could be implemented in several different ways and have several different appearances.

What is claimed is:

1. A method of estimating video global motion comprising:
a. down-sampling a first video frame and a second video frame, wherein the down-sampling produces a first low resolution image and a second low resolution image, the first low resolution image corresponding to the first video frame and the second low resolution image corresponding to the second video frame;
b. block matching the first low resolution image and the second low resolution image, wherein the block matching produces a motion vector; and
c. performing a gradient-based estimation on the first low resolution image and the second low resolution image, wherein the gradient-based estimation includes the motion vector, and further wherein an estimated global motion is calculated.

2. The method according to claim 1, further comprising receiving the first video frame and the second video frame from a camera.

3. The method according to claim 1, further comprising receiving the first video frame and the second video frame from a storage device.

4. The method according to claim 1, further comprising applying the estimated global motion to a selected application.

5. The method according to claim 1, further comprising transmitting the first video frame and the second video frame to a display when the estimated global motion is calculated.

6. The method according to claim 1, further comprising transmitting the first video frame and the second video frame to a storage device when the estimated global motion is calculated.

7. The method according to claim 1, further comprising transmitting the first video frame and the second video frame to an application when the estimated global motion is calculated.

8. The method according to claim 1, wherein the block matching includes utilizing a plurality of pixels, further wherein the plurality of pixels have position coordinates in x and y directions.

9. The method according to claim 1, wherein the block matching calculates a lowest sum of absolute differences.

10. The method according to claim 1, further comprising segmenting the second low resolution image into two regions according to the motion vector.

11. The method according to claim 1, wherein the gradient-based estimation includes refining the motion vector and calculating a set of motion components, further wherein the motion components include a horizontal component, a vertical component, a zooming component and a rotational component.

12. The method according to claim 11, wherein the motion components are calculated with a least squares method.

13. A system for estimating video global motion comprising:
a. means for down-sampling a first video frame and a second video frame, wherein the means for down-sampling produces a first low resolution image and a second low resolution image, the first low resolution image corresponding to the first video frame and the second low resolution image corresponding to the second video frame;
b. means for block matching the first low resolution image and the second low resolution image, wherein the block matching produces a motion vector; and
c. means for performing a gradient-based estimation on the first low resolution image and the second low resolution image, wherein the means for performing the gradient-based estimation includes the motion vector, and further wherein an estimated global motion is calculated.

14. The system according to claim 13, further comprising means for receiving the first video frame and the second video frame from a camera.

15. The system according to claim 13, further comprising means for receiving the first video frame and the second video frame from a storage device.

16. The system according to claim 13, further comprising means for applying the estimated global motion to a selected application.

17. The system according to claim 13, further comprising means for transmitting the first video frame and the second video frame to a display when the estimated global motion is calculated.

18. The system according to claim 13, further comprising means for transmitting the first video frame and the second video frame to a storage device when the estimated global motion is calculated.

19. The system according to claim 13, further comprising means for transmitting the first video frame and the second video frame to an application when the estimated global motion is calculated.

20. The system according to claim 13, wherein the means for block matching includes means for utilizing a plurality of pixels, further wherein the plurality of pixels have position coordinates in x and y directions.

21. The system according to claim 13, wherein the means for block matching calculates a lowest sum of absolute differences.

22. The system according to claim 13, further comprising means for segmenting the second low resolution image into two regions according to the motion vector.

23. The system according to claim 13, wherein the means for gradient-based estimation includes means for refining the motion vector and means for calculating a set of motion components, further wherein the motion components include a horizontal component, a vertical component, a zooming component and a rotational component.

24. The system according to claim 23, wherein the motion components are calculated with a least squares method.

25. A system for estimating video global motion comprising:
a. a receiver configured to receive a first video frame and a second video frame; and
b. a processor coupled to the receiver, wherein the processor is configured to:
i. down sample the first video frame and the second video frame, wherein the down-sampling produces a first low resolution image and a second low resolution image, the first low resolution image corresponding to the first video frame and the second low resolution image corresponding to the second video frame;
ii. block match the first low resolution image and the second low resolution image, wherein the block matching produces a motion vector; and
iii. perform a gradient-based estimation on the first low resolution image and the second low resolution image, wherein the gradient-based estimation includes the motion vector, and further wherein an estimated global motion is calculated.

26. The system according to claim 25, wherein the receiver receives the first video frame and the second video frame from a camera.

27. The system according to claim 25, wherein the receiver receives the first video frame and the second video frame from a storage device.

28. The system according to claim 25, wherein the processor is configured to apply the estimated global motion to a selected application.

29. The system according to claim 25, further comprising a transmitter configured to transmit the first video frame and the second video frame to a display when the estimated global motion is calculated.

30. The system according to claim 25, further comprising a transmitter configured to transmit the first video frame and the second video frame to a storage device when the estimated global motion is calculated.

31. The system according to claim 25, further comprising a transmitter configured to transmit the first video frame and the second video frame to an application when the estimated global motion is calculated.

32. The system according to claim 25, wherein when the processor performs block matching, a plurality of pixels is utilized, further wherein the plurality of pixels have position coordinates in x and y directions.

33. The system according to claim 25, wherein block matching calculates a lowest sum of absolute differences.

34. The system according to claim 25, wherein the processor is configured to segment the second low resolution image into two regions according to the motion vector.

35. The system according to claim 25, wherein when the processor performs gradient-based estimation, the motion vector is refined and a set of motion components is calculated, further wherein the motion components include a horizontal component, a vertical component, a zooming component and a rotational component.

36. The system according to claim 35, wherein the motion components are calculated with a least squares method.

37. A method of estimating video global motion comprising:
a. receiving a first video frame and a second video frame;
b. down-sampling the first video frame and the second video frame, wherein the down-sampling produces a first low resolution image and a second low resolution image, the first low resolution image corresponding to the first video frame and the second low resolution image corresponding to the second video frame;
c. block matching the first low resolution image and the second low resolution image, wherein the block matching produces a motion vector;
d. performing a gradient-based estimation on the first low resolution image and the second low resolution image, wherein the gradient-based estimation includes the motion vector, and further wherein an estimated global motion is calculated;
e. applying the estimated global motion to a selected application; and
f. transmitting the first video frame and the second video frame.

38. The method according to claim 37, wherein the first video frame and the second video frame are received from a camera.

39. The method according to claim 37, wherein the first video frame and the second video frame are received from a storage device.

40. The method according to claim 37, wherein the first video frame and the second video frame are transmitted to a display when the estimated global motion is calculated.

41. The method according to claim 37, wherein the first video frame and the second video frame are transmitted to a storage device when the estimated global motion is calculated.

42. The method according to claim 37, wherein the first video frame and the second video frame are transmitted to an application when the estimated global motion is calculated.

43. The method according to claim 37, wherein the block matching includes utilizing a plurality of pixels, further wherein the plurality of pixels have position coordinates in x and y directions.

44. The method according to claim 37, wherein the block matching calculates a lowest sum of absolute differences.

45. The method according to claim 37, further comprising segmenting the second low resolution image into two regions according to the motion vector.

46. The method according to claim 37, wherein the gradient-based estimation includes refining the motion vector and calculating a set of motion components, further wherein the motion components include a horizontal component, a vertical component, a zooming component and a rotational component.

47. The method according to claim 46, wherein the motion components are calculated with a least squares method.

48. A system for estimating video global motion comprising:
a. a processing circuit for down-sampling a first video frame and a second video frame, wherein the processing circuit for down-sampling produces a first low resolution image and a second low resolution image, the first low resolution image corresponding to the first video frame and the second low resolution image corresponding to the second video frame;
b. a matching circuit for block matching the first low resolution image and the second low resolution image, wherein the block matching produces a motion vector; and
c. an estimating circuit for performing a gradient-based estimation on the first low resolution image and the second low resolution image, wherein the estimating circuit for performing the gradient-based estimation includes the motion vector, and further wherein an estimated global motion is calculated.

49. The system according to claim 48, further comprising a receiver for receiving the first video frame and the second video frame from a camera.

50. The system according to claim 48, further comprising a receiver for receiving the first video frame and the second video frame from a storage device.

51. The system according to claim 48, further comprising an application circuit for applying the estimated global motion to a selected application.

52. The system according to claim 48, further comprising a transmitter for transmitting the first video frame and the second video frame to a display when the estimated global motion is calculated.

53. The system according to claim 48, further comprising a transmitter for transmitting the first video frame and the second video frame to a storage device when the estimated global motion is calculated.

54. The system according to claim 48, further comprising a transmitter for transmitting the first video frame and the second video frame to an application when the estimated global motion is calculated.

55. The system according to claim 48, wherein the matching circuit for block matching utilizes a plurality of pixels, further wherein the plurality of pixels have position coordinates in x and y directions.

56. The system according to claim 48, wherein the matching circuit for block matching calculates a lowest sum of absolute differences.

57. The system according to claim 48, further comprising a segmenting circuit for segmenting the second low resolution image into two regions according to the motion vector.

58. The system according to claim 48, wherein the estimating circuit for gradient-based estimation refines the motion vector and calculates a set of motion components, further wherein the motion components include a horizontal component, a vertical component, a zooming component and a rotational component.

59. The system according to claim 58, wherein the motion components are calculated with a least squares method.
